(19) United States
(12) Patent Application Publication
(10) Pub. No.: US 2006/0043121 A1
(43) Pub. Date: Mar. 2, 2006

(54) Hot melt dispenser with silicone valve

(76) Inventor: Richard A Belanger, Kensington, NH (US)

Correspondence Address: CLARK & BRODY, 1090 VERMONT AVENUE, NW, SUITE 250, WASHINGTON, DC, 20005, US

(21) Appl. No.: 10/538,325

(22) PCT Filed: Jun. 1, 2004
(86) PCT No.: PCT/US04/17205

§ 371 Date: Jun. 10, 2005

Related U.S. Application Data
(60) Provisional application No. 60/473,930, filed on May 29, 2003.

(51) Int. Cl. B67D 5/42

(52) U.S. Cl. 222/387

(57) ABSTRACT

A dispenser for a liquid or semi-solid material includes a container having a valve element at one end and a piston at the other. The valve element includes central and annular portions, the annular portion forming a good seal with the interior of the container and the central portion having a plurality of resilient flaps forming a valve. The dispenser is easily assembled because the valve element may be placed in the container without special tools or retaining structure, and the valve element is retained in place by the material. The valve element includes an annular sealing portion that flexes outwardly against the interior wall of the container during dispensing of the material. The central portion having the flaps is relatively thick to provide good restoring power to the flaps, and it is recessed from the front wall of the valve to provide space for the flaps to open when the valve is in contact with the front wall of the container.

### TECHNICAL FIELD

This invention relates to the art of dispensers for liquid, semi-liquid, or paste materials. In the preferred embodiment, the invention relates to a dispenser for hot melt materials including polyurethane.

### BACKGROUND

It is known to provide a dispenser for a semi-liquid material, such as uncured caulk in the form of a tube with a plunger that is urged along the tube to dispense the material. Such tubes are often provided with frangible closures that seal the tube before use and are broken in the first use. It is also known to provide hot melt adhesive dispensers with check valves, such as spring-loaded mechanical valves, which open in response to the pressure of the material during application and then close to prevent dripping of the melted material.

The use of mechanical check valves has been limited to devices that will be reused because of the cost of the valves. It has not been economical to use mechanical check valves with the caulk-type applicators because the valves would be discarded along with the tube.

It is also known to use flap-style check valves having resilient flaps that form the valve. This type of valve is generally used with liquids and at low temperatures.

### SUMMARY OF THE INVENTION

In accordance with the invention, a dispenser includes an inexpensive valve that prevents dripping of the dispensed material when the dispensing pressure is removed. The dispenser may be in the form of a tube or a bottle, and the materials to be dispensed may be any of a wide variety of liquid, semi-liquid, or paste materials including hot-melt compositions such as adhesives and hot-melt polypropylene. Additional materials that may be dispensed using the devices of the invention include those having viscosities ranging between toothpaste and heavy oils.

While it may be made of any elastomer, the valve of the invention is preferably made of a substance that withstands higher temperatures, such as those temperatures used during the melting of hot-melt materials. For example, such materials are routinely heated to approximately 200° F. to 300° F. and even as high as 450° F. As well, the valve is preferably made of a substance to which the hot melt materials do not generally adhere. The valve is preferably made of silicone because silicone does not stick to hot melt adhesives and is capable of withstanding higher temperatures. As well, silicone is easily molded.

The valve of the invention is preferably in the form of a disc that fits into a tubular dispenser so that it engages and seats on a front wall of the tube and also engages the interior wall of the tube to form a seal without requiring an additional retaining element. It will be appreciated, however, that the dispenser may be of a variety of types, e.g., a bottle and may have a variety of cross sectional configurations, e.g., square, circular, oval, etc. The peripheral seal is accomplished at least in part by providing the valve with a relatively thick marginal edge that cooperates with the internal wall of the dispenser to retain the valve upright and in the operative position. The marginal edge is configured generally to match the cross section of the dispenser, and it is preferably flexible whereby the valve can be sized to engage the interior wall of the dispenser and yet be easily assembled in the dispensed. The rear of the valve is provided with a recess adjacent the marginal edge whereby pressure applied by the material during dispensing pushes the marginal edge outward against the interior of the container to tightly contact with the sidewall when dispensing the material.

A portion of the front wall of the valve is preferably shaped to engage and cooperate with the front wall of the dispenser to provide yet another area for sealing. For example, the front wall of the valve may be conical to cooperate with a generally conical front wall of the dispenser. The central region of the front of the valve is recessed adjacent the flaps to provide space for the flaps to open to dispense material.

In accordance with another aspect of the invention, a container is provided with a unique two-part piston for applying pressure to fluid or semi-fluid contents of the container to express the contents. A first part of the piston is made of a material that is flexible and provides a seal that maintains pressure in the container, which will be located adjacent to the contents of the container. A second part of the piston is formed of a relatively rigid material and engages an advancing mechanism. Preferably the first part is molded of silicone and has a cross section that matches that of the interior of the container. The two parts are held together by a snap connection to form a single unit.

It is an object of this invention to provide a unique valve for a pressurized container.

It is an object of this invention to provide a unique container for dispensing materials, the container having a unique outlet valve that prevents dripping and a unique piston that maintains pressure during dispensing.

### BRIEF DESCRIPTION OF THE DRAWINGS

FIG. 1 is a partial cross section of a dispenser tube in accordance with the invention having the inventive valve and piston installed therein.

FIG. 2 is a side view of a valve in accordance with the invention.

FIG. 3 is a front perspective view of the valve of FIG. 2.

FIG. 4 is a rear perspective view of a valve of FIG. 3.

FIG. 5a is an exploded perspective of a piston in accordance with the invention.

FIG. 5b is a perspective of the piston of FIG. 5a.

### DETAILED DESCRIPTION OF THE PREFERRED EMBODIMENT

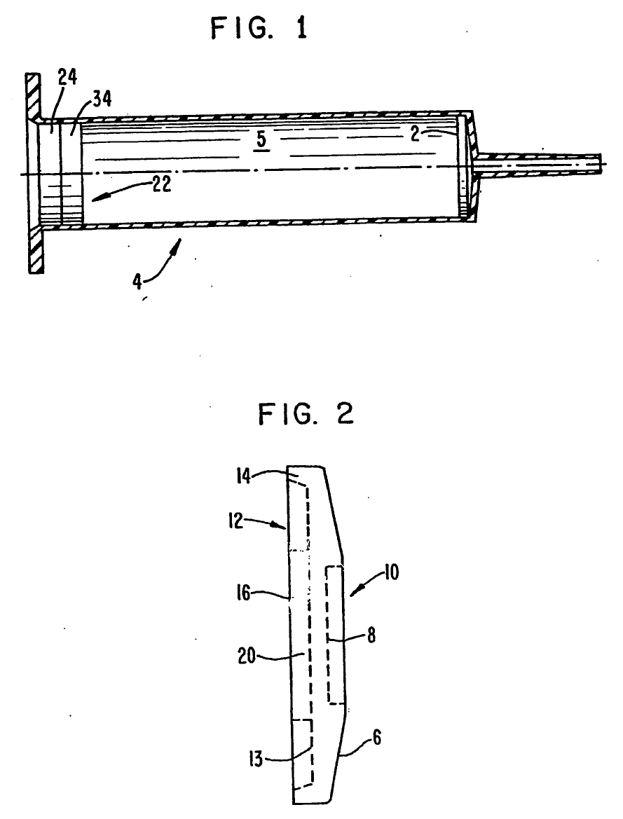

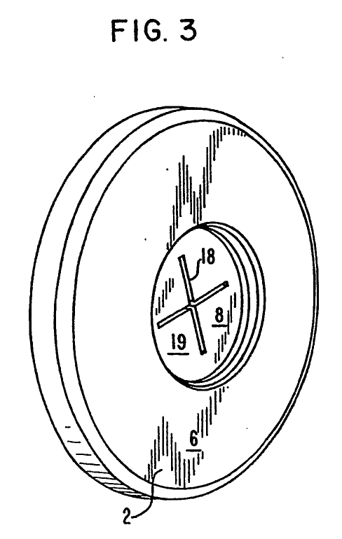

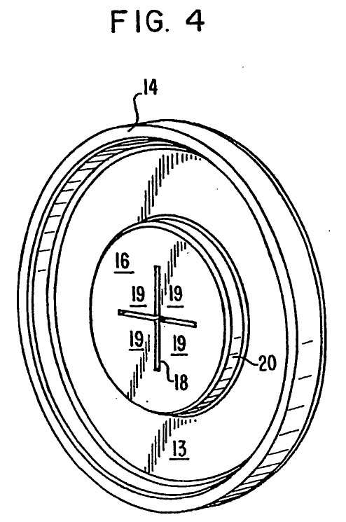

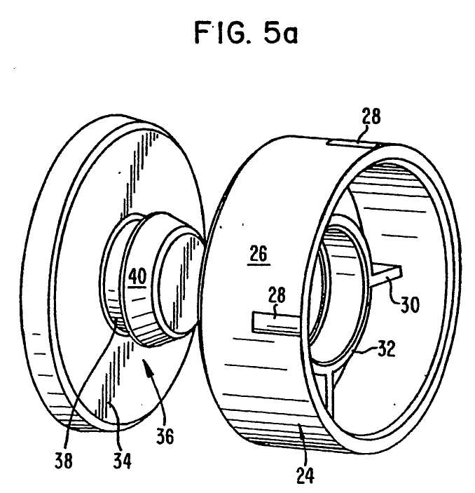

With reference to FIGS. 1 through 4, a valve 2 in accordance with the invention is made of a flexible material, preferably molded silicone, and sized to fit in the forward part of a tube-type dispenser 4 as illustrated in FIG. 1. Thus, the dispenser forms a cavity 5 for receiving materials to be dispensed, and the valve 2 is placed at the forward end of that cavity. A piston 22 for applying pressure to the material during dispensing lo located at the other end of the cavity.

The valve 2 is preferably in the form of a circular disc designed to fit in a cylindrical tube such as that shown at 4 in FIG. 1. Of course, other peripheral shapes may be used depending on the configuration of the dispenser, it being contemplated that the container may take any of a wide variety of configurations.

It will be appreciated that the valve 2 includes a conical front wall 6 that is annular, and a central section 20 having a front wall 8 displaced from the front wall 6 to form a depression 10. The rear wall of the valve includes an annular depression 12 formed by a displaced surface 13, which lies between a marginal edge portion 14 and a rear surface 16. The portion of the valve between the front surface 8 and the rear surface 16 is provided with slits 18 to form valve flaps 19. In the embodiment shown, two perpendicular slits form four symmetrical triangular flaps 19. Other shapes for the flaps are possible. For example, if the slits are not perpendicular or intersect at different locations, the shapes of the flaps will vary.

The configuration shown provides several advantages. The relatively thick central section 20 of the valve provides increased resiliency for the flaps 19. This extra thickness causes the flaps to return quickly to their original positions after pressure on the contents of the container is reduced to ensure closing upon release of dispensing forces in the material. The use of the relatively thick marginal edge portion along with the depression 12 allows the edge portion to act as a U-cup to flex upon outward upon application of pressure to ensure good contact with the interior of the tube and provide a good seal during dispensing of the contents.

The depression 10 on the front of the valve allows space for the flaps 19 to open when the front wall 6 of the valve is in contact with the interior surface of the front wall of the container, as shown in FIG. 1.

Use of silicone for the valve is advantageous because it provides a wide range of Durometer options and withstands temperatures up to about 450° F.

The container 4 of FIG. 1 also illustrates installation of the unique piston 22 in accordance with the invention. The piston is shown at one end of the dispenser container 4, and it will be appreciated that a variety of mechanisms may be used to advance the piston to apply pressure to the contents of the container during dispensing. For example, the mechanism may be similar to that of a syringe or it may be a mechanism associated with another structure, such as a handle for removably receiving containers of the type shown.

In a preferred embodiment, the overall diameter of the disc is about 0.82 inch to 1.01 inch and preferably 0.916 inch, and the thickness of the central section 20 is from about 0.9 inch to about 1.1 inch and preferably 0.1 inch. The thickness of the central part is about seventy percent of the maximum thickness of the disc. The minimum radial thickness of the marginal edge portion is about 0.037 inch and tapers toward the rear wall of the annular portion. The recess 10 is from about 0.04 inch to 0.05 inch and preferably 0.046 inch. The diameter of the front surface 8 is about 0.335 inch to 0.420 inch and preferably 0.374 inch. The depth of the recess in the front is about 0.041 inch to 0.050 inch and preferably 0.046 inch. The longitudinal dimension of the marginal edge is 0.090 inch to 1.1 inch and preferably about 0.100 inch to provide adequate stability and sealing.

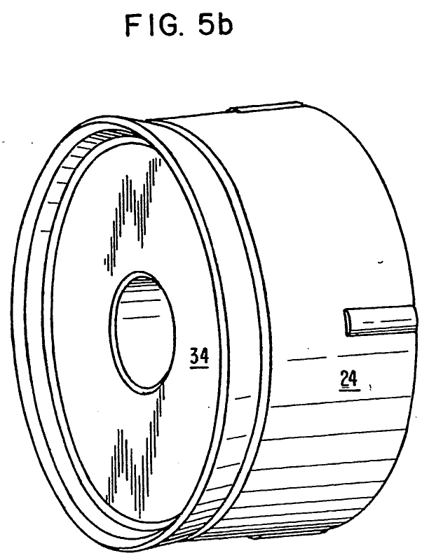

The preferred construction for the piston 22 is shown in FIGS. 5a and 5b. The rear part 24 of the piston, i.e., the part further from the dispensing end of the container, is preferably made of a somewhat rigid material that is capable of transmitting dispensing forces without substantial deformation. This part is shown as being cylindrical, which is the preferred form when the dispenser 4 is tubular. Thus, the part 24 includes a cylindrical side wall 26 with protrusions 28 arranged to ensure a good fit with the interior of the dispenser and to prevent binding. The interior of the front part 24 may be hollow to reduce the quantity of material required, and strengthening ribs 30 may be used as illustrated. A central opening is formed by an interior shoulder 32, and forms a connection with the second part 34 of the piston. The second part is preferably thin, e.g., disc-like, and is made of molded silicone of such a Durometer that it is flexible and forms a good seal with the interior of the dispenser. The front part 34 is placed adjacent the material to be dispensed and includes a protrusion 36 that extends rearward of the main body of the element to pass through the opening formed by the shoulder 32 and engage it to couple the two together. The protrusion preferably includes a straight section 38 and a slope surface 40 to provide a snap fit between the elements. Of course, other connecting arrangements known in the art are possible.

FIG. 5b shows the two parts 24 and 34 connected together forming a single unit.

Modifications within the scope of the appended claims will be apparent to those of skill in the art.

I claim:

1. A valve comprising a central portion, an annular portion, and a marginal edge, a front wall of said central portion is displaced from the front wall of said annular portion, a rear wall of said annular portion is recessed from a rear wall of said central portion and a rear wall of said marginal edge, and said central portion is slit to provide at least one movable flap forming a valve for dispensing material.

2. A valve according to claim 1 wherein said front wall of annular portion is conical.

3. A valve according to claim 1 wherein said valve is made of molded silicone.

4. A dispenser forming a cavity for containing material to be dispensed and having a valve at one end of said cavity and a valve at an opposed end, wherein said valve comprises a central portion, an annular portion, and a marginal edge, a front wall of said central portion is displaced from the front wall of said annular portion, a rear wall of said annular portion is recessed from a rear wall of said central portion and a rear wall of said marginal edge, and said central portion is slit to provide at least one movable flap forming a valve for dispensing material.

5. A dispenser according to claim 4 wherein said material to be dispensed comprises hot melt adhesive and said valve is made of silicone.

6. A dispenser according to claim 4 wherein said piston comprises a first part engaging said material and providing an annular seal with the interior of said cavity and a second part of more rigid material.

7. A dispenser according to claim 6 wherein said first and second parts are connected to each other to form a single unit.
